(19) United States
(12) Patent Application Publication
(10) Pub. No.: US 2026/0011079 A1
(43) Pub. Date: Jan. 8, 2026

(54) INFORMATION PROCESSING DEVICE FOR DISPLAYING AVATAR OF USER IN VIRTUAL SPACE, INFORMATION PROCESSING METHOD, AND NON-TRANSITORY COMPUTER READABLE MEDIUM

(71) Applicant: CANON KABUSHIKI KAISHA, Tokyo (JP)

(72) Inventor: Hiroto OKA, Kanagawa (JP)

(21) Appl. No.: 19/328,243

(22) Filed: Sep. 15, 2025

Related U.S. Application Data
(63) Continuation of application No. PCT/JP2023/043593, filed on Dec. 6, 2023.

(30) Foreign Application Priority Data
Mar. 16, 2023 (JP) 2023-041630

(51) Int. Cl. G06T 17/00; G06T 3/40

(52) U.S. Cl. CPC G06T 17/00; G06T 3/40

(57) ABSTRACT

An information processing device includes one or more processors and/or circuitry configured to: execute display control processing of performing control so as to display an avatar of a first user for each user participating in a same virtual space as the first user, wherein in the display control processing, the avatar of the first user is displayed in a first display form, among a plurality of display forms, in a user terminal of a second user participating in the same virtual space as the first user, and the avatar of the first user is displayed in a second display form, among the plurality of display forms, different from the first display form in a user terminal of a third user participating in the same virtual space as the first user.

### CROSS-REFERENCE TO RELATED APPLICATIONS

This application is a Continuation of International Patent Application No. PCT/JP2023/043593, filed Dec. 6, 2023, which claims the benefit of Japanese Patent Application No. 2023-041630, filed Mar. 16, 2023, both of which are hereby incorporated by reference herein in their entirety.

### BACKGROUND

### Field of the Technology

The present disclosure relates to an information processing device, an information processing method, and a non-transitory computer readable medium.

### Description of the Related Art

With the development and spread of virtual reality (VR, Virtual Reality) technology, it has been studied to use a virtual space for various purposes such as distribution, business, and medical care. For example, regarding the application to the medical field, even a patient who has difficulty going out due to a physical or mental disorder or a patient who lives in a place where it is difficult to go to a hospital such as a remote island can receive medical care and counseling in a virtual space. Furthermore, by using an avatar (the virtual self of the user in the system) in the virtual space, even for a patient whose face is widely known or a patient who cares about surrounding eyes, the patient can speak frankly without having one's face seen by other users, and thus it becomes easy to participate in an examination and counseling.

A method called group counseling is a method of counseling conducted by gathering a plurality of patients. In group counseling, patients can see themselves more easily through the reactions and human relationships of others, and can view things more flexibly by incorporating the ideas and viewpoints of others.

Research has been published that a user is more likely to be prompted to self-disclose by using an avatar that does not resemble the user. In the group counseling held in the virtual space, it is expected that more effective counseling can be performed by a patient using an avatar that does not look like him/her.

In group counseling, it is desirable for a patient to use an avatar that is far from his/her actual facial image, from the standpoint of privacy protection and because the patient can speak their own real feelings without caring about his/her surrounding eyes. However, it is not desirable for a patient to use an avatar because a psychiatrist or a counselor can gauge the mental state, the weight of symptoms, and the like by looking at the patient's actual expression. That is, when the avatar of the patient is displayed on the terminal of another user, an appropriate display form of the avatar differs depending on whether the position of the other user is a psychiatrist or a counselor or another patient.

Even for purposes other than group counseling, when displaying the avatar of the user on the terminal of another user in the virtual space, an appropriate display form of the avatar may be different according to the position of the other user. As an example, when the user conducts business negotiations in the virtual space, there is a case where the user wants to display an avatar that the user himself/herself usually uses for a user who is a colleague and display an avatar of an appearance of a business man in order to give a better impression to the user who is a business partner. As another example, when performing a live show in a virtual space, an organizer may want to display a real avatar faithfully imitating an actual appearance of a performer for a user who has purchased a ticket, and display an avatar with a deformed performer for a user who has not purchased a ticket. By switching the avatar, the organizer of the live can hold the live for the fan and promote the live for a user who is not the fan.

As a technique of changing the display of the avatar, Japanese Patent Laid-Open No. 2009-104482 discloses a technique of identifiably displaying the avatar of the user having a larger common activity history, such as adding a balloon. However, even in consideration of the common activity history, it may be difficult to appropriately switch the avatar according to the user's position.

### SUMMARY

The present disclosure provides a technology for displaying an avatar of a user in an appropriate display form according to a position of another user when the avatar is displayed on a terminal of the other user participating in a virtual space.

An information processing device according to the present disclosure includes one or more processors and/or circuitry configured to: execute display control processing of performing control so as to display an avatar of a first user for each user participating in a same virtual space as the first user, wherein in the display control processing, the avatar of the first user is displayed in a first display form, among a plurality of display forms, in a user terminal of a second user participating in the same virtual space as the first user, and the avatar of the first user is displayed in a second display form, among the plurality of display forms, different from the first display form in a user terminal of a third user participating in the same virtual space as the first user.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a communication system according to a first embodiment.

FIG. 2 is a diagram illustrating a hardware configuration of a user terminal.

FIG. 3 is a diagram illustrating a hardware configuration of a server.

FIG. 4 is a diagram illustrating an example of a user interface for setting how to show an avatar.

FIGS. 5A to 5D are diagrams illustrating specific examples of changing how to show an avatar.

FIG. 6A is a flowchart illustrating processing of the system according to the first embodiment.

FIG. 6B is a flowchart illustrating another processing of the system according to the first embodiment.

FIG. 7 is a diagram illustrating a configuration example of a communication system according to a second embodiment.

FIG. 8 is a flowchart illustrating processing of the system according to the second embodiment.

### DESCRIPTION OF THE EMBODIMENTS

Hereinafter, an embodiment according to the present disclosure will be described with reference to the drawings.

### First Embodiment

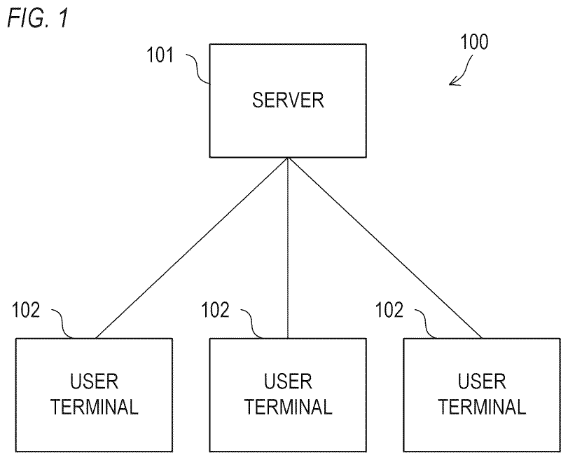

FIG. 1 is a diagram illustrating a configuration example of a communication system 100 according to a first embodiment. A communication system 100 as an example of an information processing system is a system constructed as a client-server system. The communication system 100 is applied to, for example, a telemedicine assistance system.

The communication system 100 includes a server 101 and a plurality of user terminals 102 connected to the server 101 via a network such as the Internet. The server 101 is, for example, a personal computer (PC). The user terminal 102 is, for example, an electronic device such as a PC, a smartphone, a tablet, a head mounted display (HMD), and a controller capable of communicating with the HMD. In the following description, the user terminal 102 is the HMD. The communication system 100 may include other electronic devices in addition to the HMD as the user terminal 102, and may include different types of electronic devices. In the following description, the HMD has a function of being directly connectable to a network. Note that the HMD may be connected to a network via another PC, a smartphone, or the like.

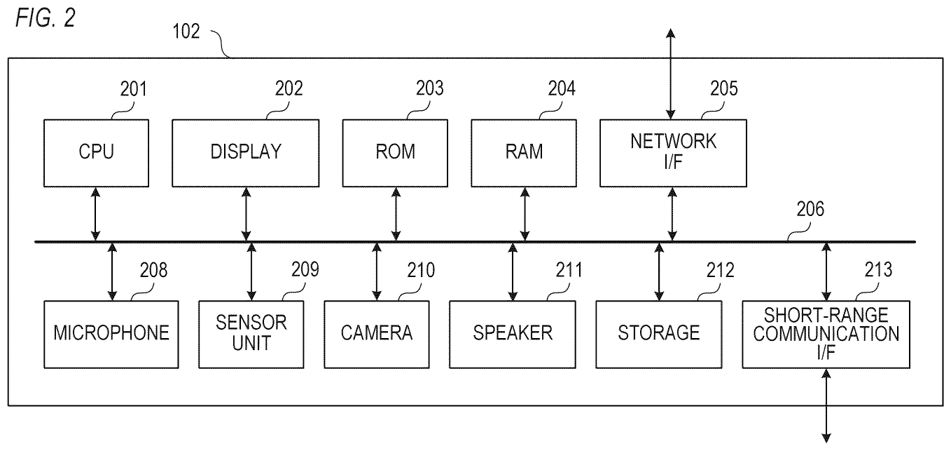

FIG. 2 is a diagram illustrating a hardware configuration of the user terminal 102. A CPU 201 comprehensively controls various functions of the user terminal 102 via an internal bus 206 by a program stored in a Read Only Memory (ROM) 203. Various processing executed by the user terminal 102 is realized by the CPU 201. The CPU 201 can project and display the execution result of the program as a video in the field of view of the user by a display 202.

The ROM 203 is, for example, a flash memory or the like, and stores various setting information, an application program, and the like. A Random Access Memory (RAM) 204 functions as a memory and a work area of the CPU 201. A network interface (I/F) 205 is a module for connecting to a network.

Although simply illustrated in FIG. 2, a sensor unit 209 includes one or more sensors. Specifically, the sensor unit 209 includes at least one of sensors such as a Global Positioning System (GPS), a gyro sensor, an acceleration sensor, a proximity sensor, and a blood pressure/heart rate/brain wave measurement sensor. The sensor unit 209 may include a sensor capable of detecting biometric information for realizing fingerprint authentication, vein authentication, iris authentication, and the like.

The camera 210 is, for example, a fisheye camera mounted inside the HMD as the user terminal 102, and has a function of photographing the user's face. The photographed image data is stored in the RAM 204 after distortion due to the fisheye lens is removed. A storage 212 is a storage medium and is a device that stores various data such as an application.

A short-range communication I/F 213 is an interface used for communication with a controller. The user can perform gesture input to the user terminal 102 by moving the held controller, or can instruct the user terminal 102 by operating a button, a joystick, or the like included in the controller. The controller may include a sensor that measures the heart rate, pulse, perspiration, and the like of the user. The user terminal 102 may communicate with a wearable device worn by the user via the short-range communication I/F 213 to acquire the heart rate, pulse, perspiration, and the like of the user. Furthermore, the user terminal 102 may communicate with a camera and a sensor group installed in the room where the user is, via the short-range communication I/F 213 to acquire information regarding the room and the user.

A microphone 208 acquires a voice uttered by the user. A speaker 211 reproduces voices, sound effects, BGM, and the like of other users participating in the communication system 100.

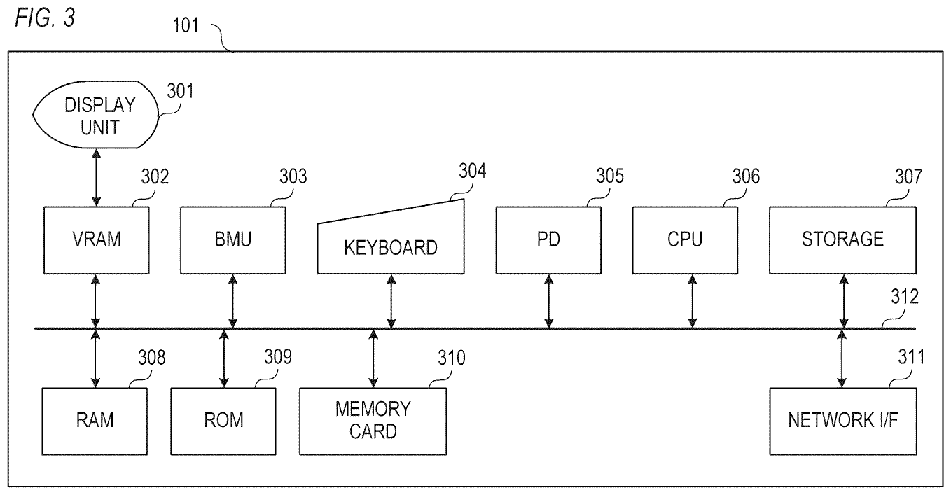

FIG. 3 is a diagram illustrating a hardware configuration of the server 101 (information processing device). The server 101 includes a display unit 301, a Video Random Access Memory (VRAM) 302, a bit move unit (BMU) 303, a keyboard 304, and a pointing device (PD) 305. In addition, the server 101 includes a CPU 306, a storage 307, a RAM 308, a ROM 309, a memory card 310, a network I/F 311, and a bus 312.

The display unit 301 displays, for example, a live view image, an icon, a message, a menu, and other user interface information. The VRAM 302 stores information of a moving image to be displayed on the display unit 301. The data generated in the VRAM 302 is transferred to the display unit 301 according to a predetermined standard and displayed on the display unit 301.

A BMU303 controls, for example, data transfer between memories (for example, between the VRAM 302 and another memory) and data transfer between a memory and each I/O device (for example, the network I/F 313).

The keyboard 304 includes various keys for inputting characters and the like. The PD 305 is used, for example, to select and instruct an icon, a menu, or other content displayed on the display unit 301, or to drag and drop an object.

The CPU 306 controls each device of the server 101 on the basis of control programs such as the OS and various programs for realizing the functions of the server 101 stored in the storage 307, the ROM 309, or the memory card 310. Various processing executed by the server 101 are realized by the CPU 306.

The storage 307 includes, for example, an HDD and an SSD. The storage 307 stores a control program, various data to be temporarily stored, and the like. The RAM 308 is used as a work area of the CPU 306, a data saving area in error processing, a load area of the control program, and the like. The ROM 309 is a nonvolatile memory and stores a control program executed by the server 101. The memory card 310 stores a control program, various data to be temporarily stored, and the like.

The network I/F 311 is an interface for communicating with the user terminal 102 and the like via a network. The bus 312 includes an address bus, a data bus, and a control bus. The CPU 306 may acquire and execute the control program from the storage 307, the ROM 309, or the memory card 310, or may acquire and execute the control program from another information processing device or the like via the network I/F 311.

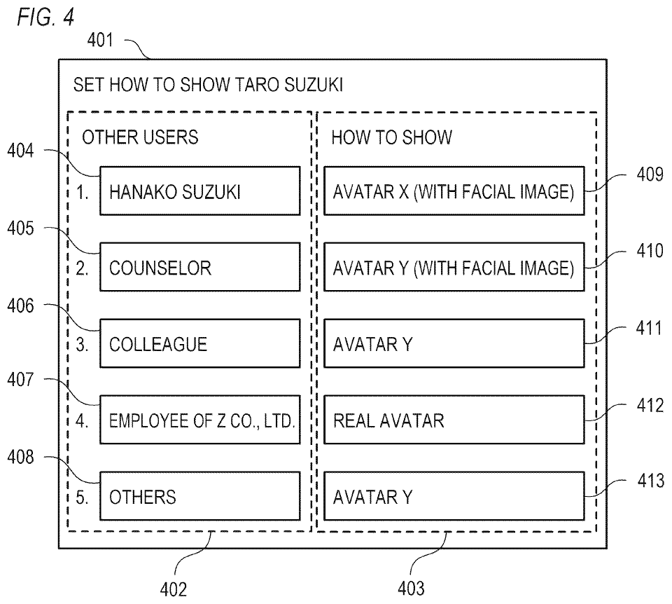

FIG. 4 is a diagram illustrating an example of a user interface (UI) for setting how to show an avatar (display form). FIG. 4 is a UI for setting how to show the avatar of the user Taro Suzuki. The information about how to show the avatar includes information such as which avatar of the avatars of the user is shown and how to show the avatar. How to show the avatar of the user may include, for example, a display form that also displays a video of the actual user with the avatar.

The setting UI 401 is displayed on the display 202 of the user terminal 102. The user can set how to show his/her avatar for each other user or for each position (category) of the other user using the setting UI 401. The user can register a plurality of display forms in advance as to how to show his/her avatar.

The server 101 may set, in the setting UI 401, the priority order for how to show the avatar set for each category of the other user. For example, the server 101 can set the priority order so as to be higher in order from the category illustrated in the upper part of the screen of the setting UI 401. The server 101 can determine how to show other user belonging to a plurality of categories on the basis of a category with a higher priority.

The other user category 402 is a UI member for setting a category of another user who is shown the avatar. For example, the user can set a specific username, qualification, predetermined group, and the like as the other user category 402.

The category 404 shows an example of directly designating a specific username (for example, Hanako Suzuki). The category 405 illustrates an example of specifying qualification of another user (for example, a counselor). The category 406 and category 407 illustrate an example in which a predetermined group (for example, a colleague, an employee of X Co., Ltd.) to which another user belongs is designated. The predetermined group is a group created by the user (Taro Suzuki in the example of FIG. 4) who sets how to show by the setting UI 401, a group registered in advance, or the like. The predetermined group may be a group indicating a relationship between the user and another user, such as a family, a friend, or a senior. The category 408 illustrates an example in which another user other than the categories 404 to 407 is designated.

How to show avatar 403 is a UI member for setting how to show the avatar for each category of another user. For example, the user can set which avatar to show and how to show the avatar as the how to show 403 of the avatar.

How to show 409 corresponding to the category 404 shows an example of setting to display the facial image of the user (Taro Suzuki) photographed by the camera 210 together with an avatar X. In other words, the server 101 performs control such that the facial images of the avatar X and Taro Suzuki are displayed on the user terminal 102 of another user (Hanako Suzuki) of the category 404.

How to show 410 corresponding to the category 405 shows an example in which a facial image of the user (Taro Suzuki) photographed by the camera 210 is set to be displayed together with an avatar Y. In other words, the server 101 performs control such that the facial images of the avatar Y and Taro Suzuki are displayed on the user terminal 102 of the another user (the counselor) in the category 404. Note that the avatar X and the avatar Y are avatars of Taro Suzuki, and are different from each other.

How to show 411 corresponding to the category 406 and how to show 413 corresponding to the category 408 show an example in which the avatar Y is set to be displayed. How to show 412 corresponding to the category 407 shows an example in which a real avatar having a 3D shape acquired from the actual face of the user (Taro Suzuki) who sets how to show as an avatar is set to be displayed.

According to the above settings, in a case where the user (Taro Suzuki) participates in group counseling in the virtual space, the server 101 can show the avatar Y with the facial image by the how to show 410 to another user who is a counselor. On the other hand, the server 101 can show the avatar Y to other users who are other patients other than Taro Suzuki without the facial image by the how to show 413.

Furthermore, in a case where the user (Taro Suzuki) participates in the virtual space together with a colleague and a business partner (for example, a staff member of X Company Limited) to discuss business, the server 101 can show the user who is a colleague the avatar Y familiar to the user who is a colleague by the how to show 411. On the other hand, the server 101 can show the real avatar to the user of the business partner by the how to show 412.

Although an example of how to show the avatar (display form) has been described above, various forms may be used as how to show the avatar. The how to show the avatar may be, for example, a form of reflecting the expression of the user on the expression of the real avatar. The server 101 can reflect the user's expression on the expression of the real avatar by analyzing the expression from the user's facial image using the expression analysis technology. According to this display form, the server 101 can transmit the expression of the user (patient) to the counselor without displaying the facial image.

The how to show the avatar may be a form of displaying a part of the facial image together with the avatar of the user instead of displaying the entire facial image of the user. For example, the server 101 may hide and display the eye portion of the facial image or display only the eye or mouth portion according to the purpose of counseling or the like. By displaying only a part of the facial image, it is possible to obtain an effect that it is difficult to identify an individual.

The how to show the avatar may be a method of reproducing the voice uttered by the user as it is together with the display of the avatar in the user terminal 102 of the other user, or a form of processing and reproducing the voice uttered by the user together with the display of the avatar so that the individual is not identified. Furthermore, how to show the avatar may be a form in which the user terminal 102 of another user displays the avatar and displays the voice uttered by the user as a subtitle without reproducing the voice. By processing the voice or displaying the voice as a subtitle, it is possible to obtain an effect of reducing a risk of identifying an individual from the voice.

The server 101 may use the purpose of communication together with the information of other users as a condition for determining how to show the avatar. The purpose of the communication may be set by the user, for example, or may be set on the basis of information regarding the virtual space. The information regarding the virtual space is information set in advance for the virtual space, and includes information such as a purpose of communication in the virtual space and a type of the virtual space (whether it is a game venue or a counseling venue) from which the purpose of communication can be analogized.

For example, in a case where the other user is a counselor, the server 101 controls the avatar of the user (patient) to be shown with a facial image in a case where the purpose of communication is counseling. On the other hand, in a case where the purpose of communication is chat, the server 101 controls the avatar of the user to be shown without a facial image. By controlling whether or not to display the facial image on the basis of the purpose of communication, an effect of suppressing the display of the facial image in a place where the facial image is unnecessary can be obtained.

The server 101 may use information regarding the virtual space together with information of another user as a condition for determining how to show the avatar. For example, in a case where the other user is a counselor, the server 101 controls the avatar of the user (patient) to be shown with a facial image in a case where the user (patient) communicates with the counselor at a counseling venue. On the other hand, the server 101 controls the avatar to be shown without a facial image in a case of communicating with a counselor in a game venue. By controlling whether or not to display the facial image on the basis of the information regarding the virtual space, for example, the information of the place where the avatar exists, an effect of suppressing the display of the facial image in a place where the facial image is unnecessary can be obtained. As a condition for determining how to show the avatar, the server 101 may use the number of times or time of communication in the past together with the information of other users. For example, in a case where the other user is a counselor, if the number of times of counseling or the time of counseling exceeds a threshold, the server 101 regards the other user as a trusted counselor, and controls the avatar to be shown with a facial image. By considering the number of times or time of communication, it is possible to obtain an effect that a facial image is displayed for a counselor who has become trusted through repeated counseling.

The server 101 may use the information of the appearance, clothing, and the like of the avatar of the other user together with the information of the other user as a condition for determining how to show the avatar. For example, when conducting business negotiations with a business partner in the virtual space, the server 101 performs control so that other users (business partner users) who use formal avatars are shown the user's formal avatar. On the other hand, the server 101 performs control to show the casual avatar of the user to another user (business partner user) who is using the casual avatar. By considering the information of other avatars, an effect that the avatar is automatically selected according to the TPO can be obtained.

The server 101 may use the information regarding the behavior of the other user together with the information of the other user as a condition for determining how to show the avatar. The information about the behavior of the other user is, for example, information indicating whether the user has purchased a live ticket or whether the user has paid for the product. For example, when the artist holds a live show in the virtual space, the server 101 can control to show the real avatar to the user who has purchased the ticket, and to show the avatar that deforms the artist to the user who has not purchased the ticket.

The server 101 may use the information of the stay time of the other user in the virtual space together with the information of the other user as a condition for determining how to show the avatar. For example, when the artist holds a live show in the virtual space, the server 101 performs control such that the user who has not purchased a ticket is shown the real avatar until a predetermined time elapses, and is shown the avatar that deforms the artist when the predetermined time elapses. In other words, the server 101 can change how to show the avatar on the basis of the stay time of the other user in the virtual space.

As to how to show the avatar, the server 101 may perform processing such as changing the resolution when displaying the avatar, applying effects such as mosaic and blurring, changing the color to monochrome, or changing the shader to a simple one. For example, when a user who is an artist holds a live show in a virtual space, the server 101 performs control to display an avatar as it is on the user terminal 102 of the user who has purchased a ticket. On the other hand, the server 101 controls the user terminal 102 of the user who has not purchased a ticket to display an avatar with a coarse resolution, mosaic, blurring, or the like.

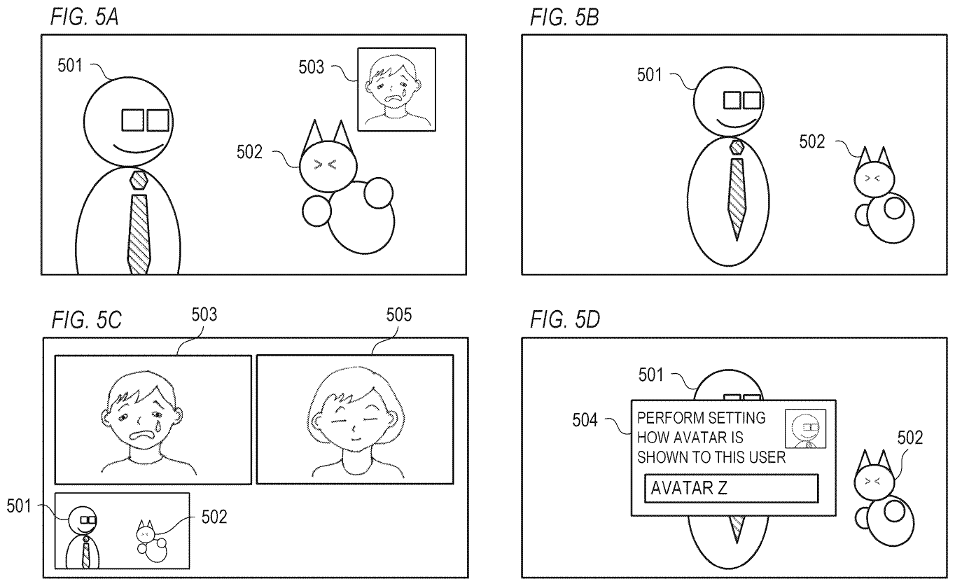

Although the settings UI 401 is assumed to be used before the user makes the avatar participate in the virtual space, the server 101 may enable a setting of how to show (display form) to other avatars while the user's avatar is participating in the virtual space. A specific example of a UI for changing how to show to other avatars while the user's avatar is participating in the virtual space will be described later with reference to FIG. 5C.

FIGS. 5A to 5D are diagrams illustrating specific examples of changing how to show an avatar. FIGS. 5A to 5D illustrate states of group counseling on the virtual space. There are four participants in the group counseling, namely, a main counselor, a sub-counselor, a patient A, and a patient B. As in the example described with reference to FIG. 4, the patient A sets such that the avatar Y is shown with the facial image to the other user who is a counselor, and the avatar Y is shown without the facial image to the other user who is a patient (other users who are “others”).

FIG. 5A illustrates a state of the virtual space viewed by the sub-counselor on his/her user terminal 102. In the sub-counselor's user terminal 102, the display 202 displays the main counselor's avatar 501 and the patient A's avatar 502. Since the patient A has set the avatar to be shown with the facial image to the counselor, the display 202 further displays the facial image 503 of the patient A. Also in the user terminal 102 of the main counselor, the display 202 displays the facial image 503 of the patient A together with the avatar of the sub-counselor and the avatar 502 of the patient A.

FIG. 5B illustrates a state of the virtual space viewed by the patient B on his/her user terminal 102. Since the patient B is at a different location in the virtual space from the sub-counselor, the angle of viewing the main counselor and the patient A is different from the sub-counselor. Since the patient B does not exist in the field of view of the sub-counselor, the avatar of the patient B is not displayed on the display 202 of the user terminal 102 of the sub-counselor as illustrated in FIG. 5A. Furthermore, since there is no sub-counselor in the field of view of the patient B, the avatar of the sub-counselor is not displayed on the display 202 of the user terminal 102 of the patient B as illustrated in FIG. 5B.

Further, since the patient A is set to show the avatar to the patient B without the facial image, the facial image of the patient A is not displayed on the display 202 of the user terminal 102 of the patient B as illustrated in FIG. 5B. That is, the facial image of the patient A is not displayed in the virtual space viewed by the patient B.

In a case where the avatar of the patient A is displayed for each of the other users participating in the same virtual space, the server 101 can perform display control to display the avatar of the patient A in different display forms on the user terminal 102 of the user of different categories on the basis of the setting of the patient A.

In a case where a PC or the like is used as the user terminal 102, with the size of the facial image 503 of the patient A illustrated in FIG. 5A, the sub-counselor may overlook a change in the detailed expression of the patient or the like. Therefore, as illustrated in FIG. 5C, the user terminal 102 may display the facial image of the other users (the patient A and the patient B) in a larger size than that in FIG. 5A so that the expression can be easily observed for the user in the position of the counselor. FIG. 5C illustrates an example in which the facial image 503 of the patient A and the facial image 505 of the patient B are displayed in an enlarged manner as compared with FIG. 5A together with a screen obtained by reducing the screen of FIG. 5A. The layout change to the screen of FIG. 5C may be executed by the user terminal 102 on the basis of information such as the position of the user, or may be executed by an instruction of the server 101. Note that the layout change to the screen of FIG. 5C may be performed in accordance with an instruction of a user such as a sub-counselor, the patient A, or the patient B.

FIG. 5D illustrates an example of a UI that sets how the user shows his/her avatar while participating in the virtual space. For example, when the patient B selects the avatar 501 of the main counselor using the controller or the like on the screen of FIG. 5B and gives an instruction to set how to show his/her avatar, the display 202 displays a setting screen 504 in the virtual space. The patient B can set how to show his/her avatar to the main counselor on the setting screen 504. The user terminal 102 receives the setting from the user, and records or updates how to show the avatar of the patient B to the main counselor. In this manner, the user can change how to show his/her avatar even while participating in the virtual space.

Note that the user terminal 102 may receive a setting as to whether or not to process the user's own voice without being limited to how to show the avatar while the user is participating in the virtual space. For example, the patient B can prevent his/her actual voice from being heard by the patient A by performing setting to select an avatar of another patient A and process the patient B's own voice for the patient A.

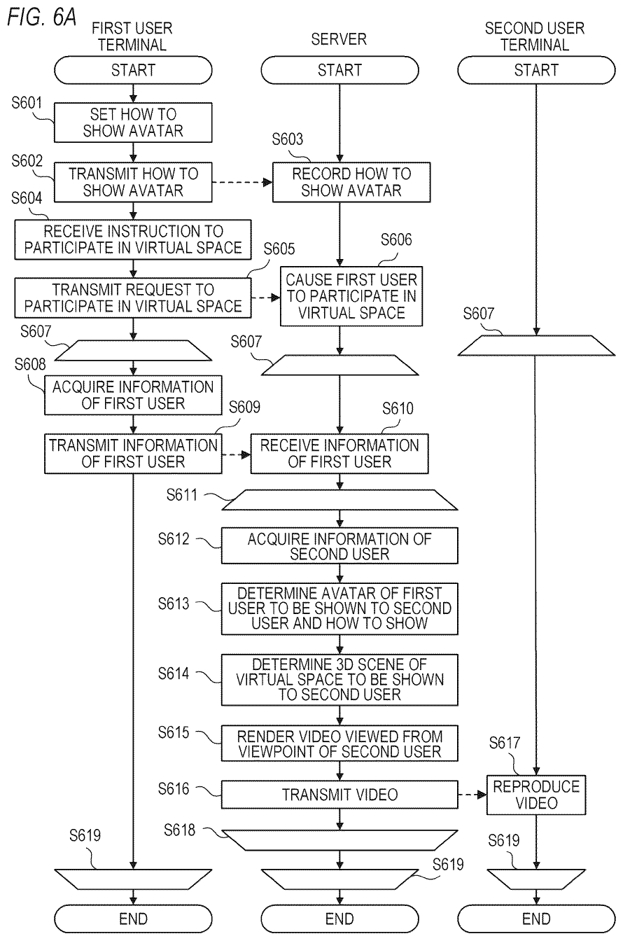

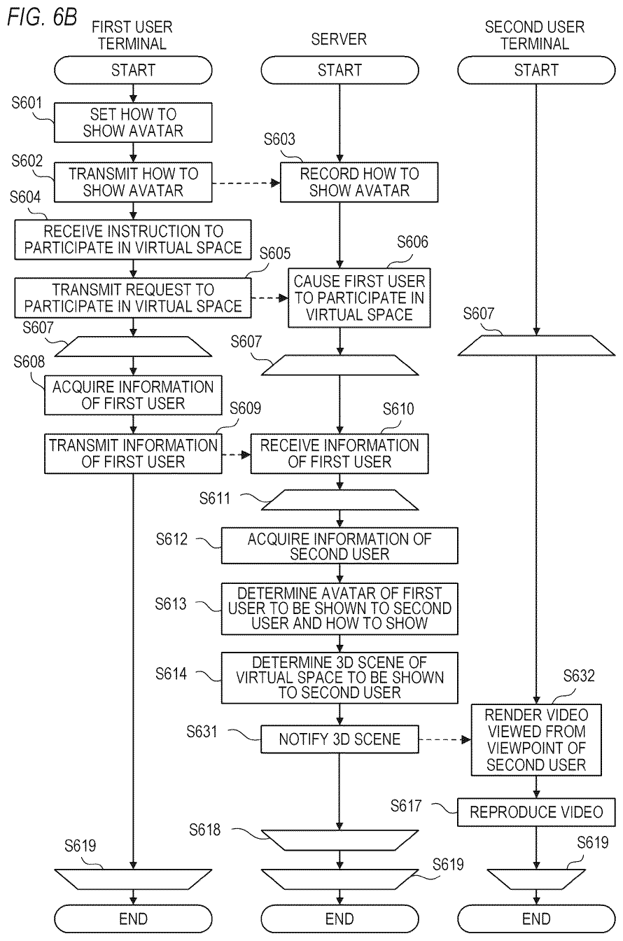

FIGS. 6A and 6B are flowcharts illustrating processing of the communication system 100 according to the first embodiment. The processing illustrated in FIG. 6A is processing using a method called remote rendering in which an image displayed on each user terminal 102 is rendered by the server 101. The processing illustrated in FIG. 6B is processing using a method called local rendering for rendering an image in the user terminal 102. The processing of the communication system 100 according to the first embodiment may be realized by using any method.

First, processing using the remote rendering of FIG. 6A will be described. FIG. 6A illustrates processing between the user terminal 102 (hereinafter, described as a first user terminal 102) of the first user and the server 101. The server 101 executes processing similar to the processing with the first user terminal 102 also with the user terminal 102 of the user other than the first user who participates in the virtual space.

Steps S601 to S603 are processing in which the first user sets how to show the avatar to another user. In step S601, the first user terminal 102 receives an instruction from the first user and sets in what display form the avatar of the first user is shown to the other user. The setting processing of how to show the avatar is as described with reference to FIG. 4. In step S602, the first user terminal 102 transmits the information on how to show the avatar set in S601 to the server 101. In step S603, the server 101 records the received information on how to show the avatar of the first user.

Steps S604 to S606 are processing of causing the first user to participate in the virtual space. In step S604, the first user terminal 102 receives an instruction to participate in the virtual space from the first user. The first user terminal 102 acquires, from the storage 212 or the like, the identification information of the virtual space in which the first user has given an instruction to participate.

In step S605, the first user terminal 102 transmits the identification information of the virtual space acquired in step S604 to the server 101, and requests the first user to participate in the virtual space. In step S606, the server 101 causes the first user to participate in the virtual space corresponding to the identification information received from the first user terminal 102.

Steps S607 to S619 are loop processing, and are repeated until all users including the first user leave the virtual space. In step S608, the first user terminal 102 acquires various types of information from the first user.

The user terminal 102 can acquire, for example, the following information. The user terminal 102 can photograph the face of the user with the camera 210 and acquire information of the expression of the user from the photographed face of the user by the expression analysis technology. The user terminal 102 can acquire the voice uttered by the user with the microphone 208. In a case where the user terminal 102 is an HMD, or in a case where the user terminal 102 is communicably connected to an HMD worn by the user, the user terminal 102 can detect the motion of the HMD with a gyro sensor and acquire information on the motion of the head of the user. The user terminal 102 communicates with a controller held by the user via the short-range communication I/F 213, and can acquire information of an avatar operation instruction input by the user using the controller. The user terminal 102 can acquire, from the controller, information on the motion of the arm of the user detected by the gyro sensor built in the controller.

In step S609, the first user terminal 102 transmits the user information acquired in step S608 to the server 101. The first user terminal 102 selects which information among the user information acquired in step S608 is transmitted to the server 101 according to how to show the avatar set in step S601. For example, in a case where the avatar of the first user and the facial image of the first user are displayed on the user terminal 102 of the second user (hereinafter, described as a second user terminal 102), the first user terminal 102 transmits the facial image of the first user together with the avatar information. In step S610, the server 101 receives the information of the first user from the first user terminal 102.

Steps S611 to S618 are loop processing, and are processing repeated by the number of second users who participate in the virtual space and watch the video of the virtual space. In step S612, for example, the server 101 acquires information regarding the second user as follows. The server 101 can refer to account information of the second user, and acquire a username of the second user, information regarding qualification, information of a group to which the second user belongs, and the like.

The server 101 may acquire the position (category such as qualification, belonging group, and the like) of the second user from an external system. For example, the server 101 inquires of an electronic medical record system in a hospital to acquire whether or not the second user is registered as a counselor. By acquiring information on the position of the second user in cooperation with an external system, the server 101 can reduce the risk of impersonation.

Furthermore, the server 101 can classify the second user on the basis of the group information set by the first user, and change how to show the avatar for each belonging group. The server 101 is only required to be able to set the group set by the first user as the position (category) of the other user. For example, a first user, who is a patient, classifies a second user, who is a counselor, into either a “trusted counselor” or an “untrusted counselor” group. The server 101 can control to display the facial image of the first user to the users in the “trusted counselor” group and not to show the facial image of the first user to the users in the “untrusted counselor” group. By allowing the first user to set up a group and classify the second user, the server 101 can display the avatar of the first user to users who are objectively in the same position in different manners.

In step S613, the server 101 determines the avatar of the first user to be shown to the second user and how to show the avatar on the basis of the information of how to show the avatar of the first user recorded in step S603.

In step S614, the server 101 determines a 3D scene of the virtual space to be shown to the second user, and generates data of the 3D scene in a data format capable of describing three-dimensional computer graphics such as X3D. The server 101 generates a 3D model of the avatar of the first user in the virtual space according to how to show the avatar of the first user determined in step S613.

In step S615, the server 101 renders the data of the 3D scene of the virtual space generated in step S614, and generates a video viewed from the viewpoint of the second user in a data format such as MP4. In step S616, the server 101 transmits the video generated in step S615 to the second user terminal 102. In step S617, the second user terminal 102 reproduces the video received from the server 101 on the display 202.

Note that, as described with reference to FIG. 4, in a case where the purpose of communication is used as the condition for determining how to show the avatar, the server 101 executes processing of acquiring the purpose of communication after execution of step S612. For example, the server 101 can receive the setting of the purpose of communication input by an arbitrary user participating in the virtual space on the user terminal 102.

Furthermore, in a case where the purpose of communication is associated as information regarding the virtual space, such as “virtual space for counseling”, the server 101 can set the purpose of communication on the basis of the information regarding the virtual space.

Furthermore, the server 101 may estimate the purpose of communication from the users participating in the virtual space. For example, in a case where a user of an account having the attribute of counselor is participating in the virtual space, the server 101 can estimate that the purpose of the communication is “counseling”. Furthermore, the server 101 may analyze the appearance of the avatar and estimate that the purpose of the communication is “consultation or counseling”, for example, if an avatar wearing a white coat is present.

As described with reference to FIG. 4, in a case where the information regarding the virtual space is used as the condition for determining how to show the avatar, the server 101 executes processing of acquiring the information regarding the virtual space after execution of step S612. The information regarding the virtual space is, for example, a name of the virtual space registered in the communication system 100, a description of the virtual space input by an administrator of the communication system 100 or a user who participates in the virtual space, furniture present in the virtual space, and the like. The server 101 can recognize the situation and the like of the virtual space by, for example, the AI technology on the basis of the information regarding the virtual space, and change how to show the avatar according to the situation and the like of the virtual space.

As described with reference to FIG. 4, in a case where the number of times or time of communication is used as the condition for determining how to show the avatar, the server 101 acquires the number of times and time of communication between the first user and the second user after execution of step S612. In order to acquire the number of times and time of communication, the server 101 records the number of times and time of communication between the first user and the second user.

The number of times of communication may be, for example, the number of times the first user and the second user have participated in the same virtual space. Furthermore, the number of times of communication may be the number of times the first user and the second user have participated in the same virtual space for a predetermined purpose. Furthermore, the number of times of communication may be the number of times the first user and the second user have participated in a specific virtual space together.

The time of communication can be, for example, a time during which the first user and the second user have a conversation with each other via the avatar. Furthermore, the time of communication can be a time during which the first user and the second user have participated in the same virtual space together. Furthermore, the time of communication can be a time during which the first user and the second user have participated in the same virtual space together for a predetermined purpose. Furthermore, the time of communication can be a time during which the first user and the second user have participated in a specific virtual space together.

As described with reference to FIG. 4, in a case where the information such as the appearance of the avatar of the other user is used as the condition for determining how to show the avatar, the server 101 executes processing of acquiring the information of the avatar of the second user after execution of step S612. The server 101 may acquire the information of the appearance of the avatar of the second user, for example, by analyzing the 3D model of the avatar of the second user with AI. Furthermore, the server 101 may acquire an avatar name of the second user, a description added by the second user to the avatar, or the like as the information on the avatar of the second user, and determine how to show the avatar of the first user on the basis of the acquired information on the avatar of the second user.

As described with reference to FIG. 4, in a case where the information regarding the behavior of the other user is used as the condition for determining how to show the avatar, the server 101 executes processing of acquiring the information regarding the behavior of the second user (other user) after execution of step S612. For example, the server 101 can acquire information on the behavior of the second user by recording the behavior history of the second user in the storage 307 or the like. Furthermore, the server 101 may inquire of an external system to acquire information on the behavior of the second user.

The information on the behavior of the user is, for example, information on whether or not the user has purchased a live ticket. In such an example of live in the virtual space, the server 101 can acquire information on whether or not the second user has purchased a ticket from a ticket sales system. The server 101 can change how to show the avatar of the first user according to whether or not the user has performed a predetermined behavior such as purchasing a ticket.

Next, processing using the local rendering of FIG. 6B will be described. Since the processing of steps S601 to S614 is the same as the processing denoted by the same reference numeral in FIG. 6A, the description thereof will be omitted.

After determining the 3D scene of the virtual space to be shown to the second user in step S614, the server 101 notifies the second user terminal 102 of the determined 3D scene in step S631. The 3D scene is represented in a data format capable of describing three-dimensional computer graphics, such as X3D.

In step S632, the second user terminal 102 renders the 3D scene of the virtual space notified from the server 101, and generates a video viewed from the viewpoint of the second user. In step S617, the second user terminal 102 reproduces the video generated in step S632 on the display 202.

According to the first embodiment described above, the first user can change how to show the avatar of the first user between a case where the other user is a counselor and a case where the other user is a patient by setting how to show the avatar via the setting UI 401 illustrated in FIG. 4. That is, the server 101 can control to display not only the avatar of the first user but also the facial image in the virtual space viewed by the counselor, and display only the avatar of the first user in the virtual space viewed by another patient. Therefore, when displaying the avatar of the first user on the user terminal 102 of the second user participating in the virtual space, the server 101 can display the avatar of the first user in an appropriate display form according to the position of the second user.

Note that the processing in step S614 in FIGS. 6A and 6B may not be executed for each second user. The server 101 can reuse the 3D scene generated in step S614 between the second users common in how to show the avatar of the first user. For example, in step S614, the server 101 may reuse the 3D scene in a case where the second user is the main counselor in the processing in a case where the second user is the sub-counselor. For users same in how to show the avatar of the first user, the server 101 can improve the processing efficiency by reusing the 3D scene of the virtual space generated in S614.

Furthermore, the setting UI 401 illustrated in FIG. 4 is assumed to be displayed on the HMD as the first user terminal 102, but the user terminal 102 is not limited to the HMD, and may be a terminal such as a PC, a smartphone, or a tablet. A terminal such as a PC, a smartphone, or a tablet as the user terminal 102 may display the setting UI 401 on the display 202 and receive an input of setting of how to show the avatar from the first user.

### Second Embodiment

In the first embodiment, the communication system 100 is constructed as a client-server system. However, the present disclosure can also be realized as a serverless system. The communication system according to the second embodiment is constructed as a serverless system.

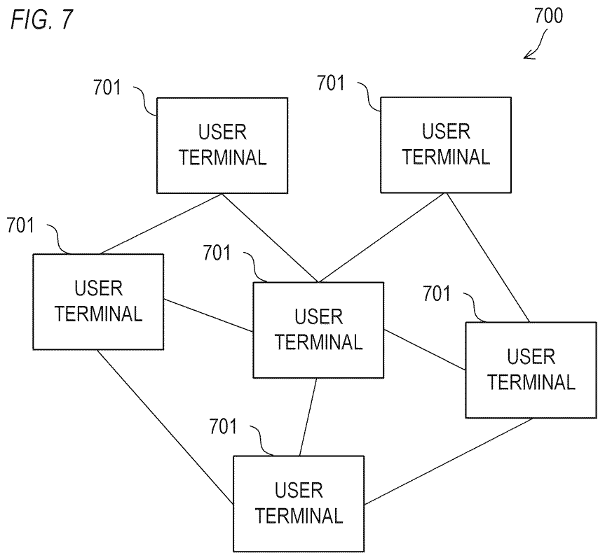

FIG. 7 is a diagram illustrating a configuration example of a communication system 700 according to the second embodiment. The communication system 700 as an example of an information processing system includes a plurality of user terminals 701 peer-to-peer connected via a network such as the Internet. Since the user terminal 701 is the same as the user terminal 102 described in the first embodiment, a detailed description thereof will be omitted. In addition, since the hardware configuration of the user terminal 701 is the same as that of the user terminal 102 of the first embodiment described with reference to FIG. 2, the description thereof is omitted. The setting UI for the user to set how to show the avatar in the second embodiment is similar to the setting UI 401 according to the first embodiment described with reference to FIG. 4.

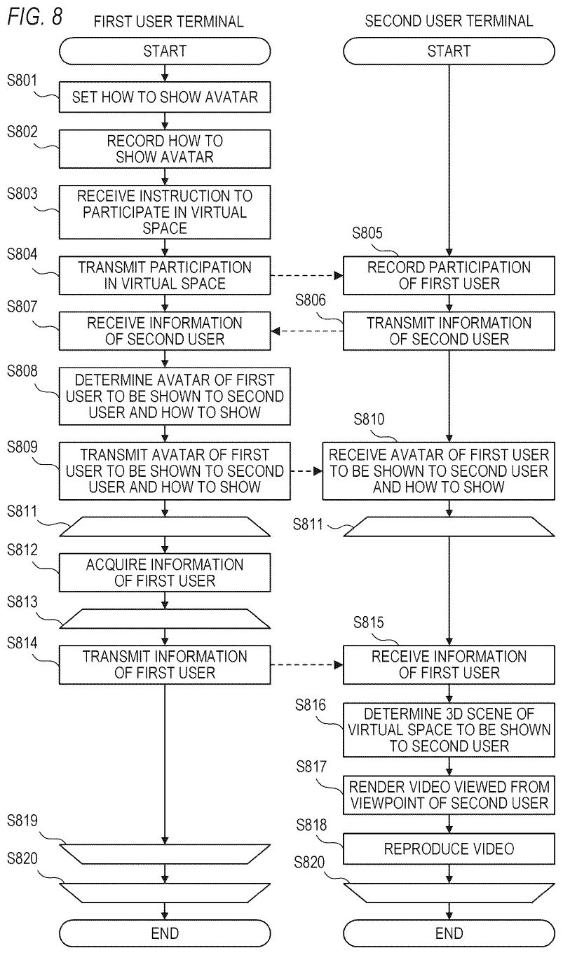

FIG. 8 is a flowchart illustrating processing of the communication system 700 according to the second embodiment. In step S801, the user terminal 701 (hereinafter, described as a first user terminal 701) of the first user receives an instruction from the first user, and sets in what display form the avatar of the first user is shown to the other user. As described with reference to FIG. 4, the first user terminal 701 can receive the setting from the first user via the setting UI 401. The processing of setting how to show the avatar is executed by the user terminal 701 of the user participating in the virtual space.

In step S802, the first user terminal 701 records the setting received from the first user in step S801 in the RAM 204, the storage 212, or the like.

Steps S803 to S810 are processing when the first user participates in the virtual space. FIG. 8 illustrates processing between the first user terminal 701 and the user terminal 701 of the second user (hereinafter, described as a second user terminal 701), but the first user terminal 701 performs the same processing with the user terminal 701 of each user participating in the virtual space.

In step S803, the first user terminal 701 receives an instruction to participate in the virtual space from the first user. The first user terminal 102 acquires, from the storage 212 or the like, the identification information of the virtual space in which the first user has given an instruction to participate.

In step S804, the first user terminal 701 transmits the identification information of the virtual space acquired in step S803 to the second user terminal 701, thereby notifying that the first user participates in the virtual space specified by the identification information. In step S805, the second user terminal 701 records that the first user has participated in the virtual space.

In step S806, the second user terminal 701 acquires information of the second user, and transmits the acquired information of the second user to the first user terminal 701. A method of acquiring the information of the second user is the same as the processing in step S612 in FIG. 6A. In step S807, the first user terminal 701 receives information on the second user from the second user terminal 701.

In step S808, the first user terminal 701 determines the avatar of the first user to be shown to the second user and how to show the avatar on the basis of the information of the second user received in step S807 and how to show the avatar of the first user recorded in step S802. Since the processing of step S808 is the same as the processing of step S613 of FIG. 6A, detailed description thereof will be omitted.

In step S809, the first user terminal 701 transmits, to the second user terminal 701, information on the avatar of the first user and how to show the avatar to be shown to the second user on the basis of the result determined in step S808. The first user terminal 701 generates, for example, a 3D model of the avatar of the first user shown to the second user in a data format capable of describing three-dimensional computer graphics such as X3D. The first user terminal 701 transmits the generated 3D model of the avatar of the first user to the second user terminal 701. Furthermore, in a case of causing the facial image of the first user to be displayed to the second user together with the avatar of the first user, the first user terminal 701 also transmits information for displaying the facial image of the first user to the second user terminal 701. In step S810, the second user terminal 701 receives, from the first user terminal 701, information of the avatar of the first user to be shown to the second user and how to show the avatar.

Steps S811 to S820 are loop processing, and are repeated until all users including the first user leave the virtual space. In step S812, the first user terminal 701 acquires various types of information from the first user. An example of the information acquired from the first user is the same as that in step S608 in FIG. 6A, and thus description thereof is omitted.

The processing from steps S813 to S819 is repeated as many times as the number of second user terminals 701 communicating with the first user terminal 701 in the virtual space. In step S814, the first user terminal 701 transmits the information of the first user acquired in step S812 to the second user terminal 701. Since the processing in step S814 is the same as that in step S609 in FIG. 6A, the description thereof will be omitted. In step S815, the second user terminal 701 receives the information of the first user from the first user terminal 701.

In step S816, the second user terminal 701 determines a 3D scene of the virtual space to be shown to the second user, and generates data of the 3D scene in a data format capable of describing three-dimensional computer graphics such as X3D. The second user terminal 701 can generate the data of the 3D scene of the virtual space shown to the second user by using the avatar of the first user and how to show the avatar received in step S810 and the information of the first user received in step S815.

In step S817, the second user terminal 102 renders the data of the 3D scene of the virtual space generated in step S816, and generates a frame of a video viewed from the viewpoint of the second user. In step S818, the second user terminal 102 reproduces the video generated in step S817 on the display 202.

According to the second embodiment described above, the serverless communication system 700 described with reference to FIG. 7 can perform control to display the avatar of the first user in a display form according to the position of the other user on the basis of the setting of how to show the avatar by the first user.

For example, the patient A who receives the counseling sets the facial image of the patient A to be displayed in the virtual space displayed on the user terminal 701 of the counselor, so that the counselor can check the actual expression of the patient A. On the other hand, by setting the facial image of the patient A not to be displayed in the virtual space displayed on the user terminal 701 of another patient B, the face of the patient A cannot be seen by the patient B, and thus the patient A can protect privacy.

When displaying the avatar of the patient A on the user terminal 701 of another user participating in the virtual space, the communication system 700 can display the avatar in an appropriate display form according to the position (psychiatrist, counselor, other patient, etc.) of the other user. That is, when displaying the avatar of the first user on the user terminal 102 of the second user participating in the virtual space, the server 101 can display the avatar of the first user in an appropriate display form according to the position of the second user.

According to the present disclosure, when displaying the avatar of the user on the terminal of another user participating in the virtual space, the avatar can be displayed in an appropriate display form according to the position of the other user.

### OTHER EMBODIMENTS

Although the present disclosure has been described in detail based on preferred embodiments thereof, the present disclosure is not limited to these specific embodiments, and various forms without departing from the gist of the present disclosure are also included in the present disclosure. Some of the above-described embodiments may be appropriately combined.

In addition, the present disclosure also includes a case where a program of software that implements the functions of the above-described embodiments is supplied from a recording medium directly or by using wired/wireless communication to a system or a device having a computer capable of executing the program, and the program is executed. Therefore, in order to realize the functional processing of the present disclosure by a computer, the program code itself supplied and installed in the computer can also realize the present disclosure. That is, a computer program itself for realizing the functional processing of the present disclosure is also included in the present disclosure. In that case, the form of the program is not limited as long as the program has the function of the program, such as the object code, the program executed by the interpreter, and the script data supplied to the OS.

The recording medium for supplying the program may be, for example, a hard disk, a magnetic recording medium such as a magnetic tape, an optical/magneto-optical storage medium, or a non-volatile semiconductor memory. The program supply method is, for example, a method in which a computer program for realizing the present disclosure is stored in a server on a computer network, and a client computer connected to the server downloads and executes the computer program.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing device comprising one or more processors and/or circuitry configured to:
execute display control processing of performing control so as to display an avatar of a first user for each user participating in a same virtual space as the first user, wherein
in the display control processing,
the avatar of the first user is displayed in a first display form, among a plurality of display forms, in a user terminal of a second user participating in the same virtual space as the first user, and
the avatar of the first user is displayed in a second display form, among the plurality of display forms, different from the first display form in a user terminal of a third user participating in the same virtual space as the first user.

2. The information processing device according to claim 1, wherein the one or more processors and/or circuitry are further configured to:
execute first acquisition processing of acquiring information of the plurality of display forms;
execute second acquisition processing of acquiring information of the second user; and
execute determination processing of determining among the plurality of display forms, the first display form on a basis of the information of the second user.

3. The information processing device according to claim 2, wherein the one or more processors and/or circuitry are further configured to execute transmission processing of generating a video of the virtual space in which the avatar of the first user is displayed in the first display form determined in the determination processing and transmit the video to a user terminal of the second user.

4. The information processing device according to claim 2, wherein the one or more processors and/or circuitry are further configured to execute notification processing of determining a scene in the virtual space in which the avatar of the first user is displayed in the first display form determined in the determination processing and notify the user terminal of the second user of the scene.

5. The information processing device according to claim 2, wherein, in the determination processing, the first display form is determined on a basis of the information of the second user and a purpose of communication between the first user and the second user.

6. The information processing device according to claim 5, wherein the purpose of the communication is set on a basis of information regarding the virtual space or set by the first user.

7. The information processing device according to claim 2, wherein, in the determination processing, the first display form is determined on a basis of the information of the second user and information regarding the virtual space.

8. The information processing device according to claim 2, wherein, in the determination processing, the first display form is determined on a basis of the information of the second user and a number of times or time of communication between the first user and the second user.

9. The information processing device according to claim 2, wherein, in the determination processing, the first display form is determined on a basis of the information of the second user and information of the avatar of the second user.

10. The information processing device according to claim 2, wherein, in the determination processing, the first display form is determined on a basis of the information of the second user and a behavior of the second user.

11. The information processing device according to claim 2, wherein, in the determination processing, the first display form is determined on a basis of the information of the second user and a stay time of the second user in the virtual space.

12. The information processing device according to claim 1, wherein the one or more processors and/or circuitry are further configured to execute first setting processing of receiving, from the first user, a setting of the first display form.

13. The information processing device according to claim 12, wherein, in the first setting processing, the setting of the display form of the avatar of the first user is received by selecting an avatar of the second user while the first user participates in the virtual space.

14. The information processing device according to claim 1, wherein the plurality of display forms include a form of displaying a 3D shape acquired from a face of the first user.

15. The information processing device according to claim 1, wherein the plurality of display forms include a form of displaying a part or all of a facial image of the first user together with the avatar of the first user.

16. The information processing device according to claim 1, wherein the plurality of display forms include a form of processing and displaying the avatar of the first user.

17. The information processing device according to claim 1, wherein the plurality of display forms include a form of enlarging and displaying a facial image of the avatar of the first user together with an image of the virtual space.

18. The information processing device according to claim 1, wherein the one or more processors and/or circuitry are further configured to execute second setting processing of receiving, from the first user, a setting as to whether or not to process a voice of the first user reproduced to the second user.

19. An information processing method for displaying an avatar of a first user for each user participating in a same virtual space as the first user, the method comprising:
displaying the avatar of the first user in a first display form, among a plurality of display forms, in a user terminal of a second user participating in the same virtual space as the first user, and
displaying the avatar of the first user in a second display form, among the plurality of display forms, different from the first display form in a user terminal of a third user participating in the same virtual space as the first user.

20. A non-transitory computer readable medium that stores a program, wherein the program causes a computer to execute an information processing method for displaying an avatar of a first user for each user participating in a same virtual space as the first user, the information processing method comprising:
displaying the avatar of the first user in a first display form, among a plurality of display forms, in a user terminal of a second user participating in the same virtual space as the first user, and
displaying the avatar of the first user in a second display form, among the plurality of display forms, different from the first display form in a user terminal of a third user participating in the same virtual space as the first user.
